(19) United States
(12) Patent Application Publication
(10) Pub. No.: US 2002/0052758 A1
(43) Pub. Date: May 2, 2002

(54) Method and apparatus for providing rights for event tickets

(76) Inventors: Roland Bushonville Arthur, Winnetka, IL (US); Norbert Peter Schenk, Chicago, IL (US)

Correspondence Address: BANNER & WITCOFF, LTD., TEN SOUTH WACKER DRIVE, SUITE 3000, CHICAGO, IL, 60606, US

(21) Appl. No.: 10/027,861

(22) Filed: Oct. 25, 2001

Related U.S. Application Data
(60) Provisional application No. 60/243,535, filed on Oct. 26, 2000.

(51) Int. Cl. G06F 17/60

(52) U.S. Cl. 705/1

(57) ABSTRACT

The present invention provides the creation and the sale of a unique stand-alone right that entitles the holder to purchase event tickets. The right can be created and distributed to a holder by an entertainment entity, entered into a commodity exchange system, transferred to a new holder (if sold by the current holder), and converted into at least one event ticket (if so elected by the holder of the right). The disclosure presents an exemplary embodiment in which a right is distributed to a season ticket and to the general public. The right is entered into a secure register, and the holder can generate or accept quotes for selling the right. If sold, the right is transferred to the new holder. The current holder can exercise the right at a cutoff date in which the right is converted into at least one ticket for post-season games.

This application is claims the benefit of U.S. Provisional Application No. 60/243,535, filed Oct. 26, 2000.

Related subject material is disclosed in co-pending U.S. patent applications Ser. No. 09/452,864 (Method and Apparatus for Use in a Commodity Exchange System), Ser. No. 09/452,907 (Apparatus for Processing Quotes in a Commodity), and Ser. No. 09/453,579 (Method and Apparatus for Establishing Commodity Markets) are incorporated by reference, all of which were filed on Dec. 2, 1999.

### FIELD OF THE INVENTION

The present invention relates to the creation and sale of a unique stand-alone right that entitles the holder to purchase event tickets.

### BACKGROUND OF THE INVENTION

Entertainment events, such as post-season games in the NFL or NBA, are not certain events and depend upon the vicissitudes of uncertain factors such as injuries to players and draft choices. With a sports team, the probability of the team participating in post-season play can vary from the very improbable to the probable; however, no one can predict a team's performance with absolute certainty.

A sports team typically gives a customer who buys a seasons ticket an implicit right to purchase post-season tickets if the team makes the playoffs. The season ticket customer decides whether or not to purchase post-season tickets by a given date. In addition, the team typically sells post-season tickets to the general public for the remaining seats on a first-come basis (typically fans wait in a long line with the anticipation of buying a playoff ticket). After post-season tickets have been distributed, fans can purchase tickets from an owner of a ticket (often such ticket owners are colloquially known as “scalpers.”)

The scenario depicted heretofore is disadvantageous both to the team as well as to the fan. The market would benefit if event tickets, e.g. post-season tickets, were distributed in an orderly and equitable basis with a right to buy playoff tickets if the team participates in post-season play. On one hand, the team could generate substantial revenue by selling rights to the fans (who are customers of the team) rather than implicitly include them with regular season tickets. On the other hand, the fans would benefit in that the fans can obtain post-season tickets in a consistent and equitable fashion, no longer depending on “scalpers,” who may cause inequities in the market.

### SUMMARY OF THE INVENTION

The present invention provides the creation and the sale of a unique stand-alone right that entitles the holder of the right the choice of purchasing event tickets. The right can assume different forms, including an attachment to a season ticket and a certificate that represents “strips” or packages representing various configurations of available events. An event can correspond one of numerous activities, including sports games (such as post-season playoffs), rock concerts, and theatrical performances. The present invention enables a right to be created and distributed to a customer (holder) by an entertainment entity (e.g. a NFL team), entered into a commodity exchange system, transferred to a new holder, and converted into at least one event ticket.

The disclosure describes an exemplary embodiment in which an entertainment entity explicitly includes a right with a season ticket and offers rights to the general public for the remaining seats. In the exemplary embodiment, the right is entered into a secure register that is logically associated with an exchange controller. The holder of the right or a potential buyer of the right can generate quotes on a commodity exchange system for selling or purchasing the right. If the holder or the buyer accepts the quote, the ownership of the right is transferred from the holder to the buyer (who becomes the new holder of the right). In the exemplary embodiment, the current holder decides whether or not to exercise the right at a cutoff date in order to purchase tickets for the playoff games of the team that distributed the right. Of course, with the vicissitudes of the team's regular season's performance, there is no guarantee that the team will play in the post-season at the time of the team issuing the right. (However, the invention does not exclude events that are effectively certain, e.g. the Olympic games being held every four years.) Consequently, a value of the right can vary throughout the season and the right can become valueless if the team does not make the post-season competition. A variation of the exemplary embodiment enables the value of the right to be adjusted during the post season according to the performance of the team during the playoff games.

### BRIEF DESCRIPTION OF THE DRAWINGS

FIG. 1 is a flow diagram illustrating a first embodiment according to the present invention;

FIG. 2 is a block diagram of a computer system in accordance with the present invention;

FIG. 3 is a block diagram of a preferred embodiment of an exchange controller in accordance with the present invention; and

FIG. 4 is a block diagram illustrating an exchange process in accordance with the present invention.

### DETAILED DESCRIPTION OF THE INVENTION

The present invention relates to the creation and sale of a unique stand-alone right (or certificate) embodying the rights to purchase event tickets. In particular, such rights may be created for any unique, recurring or one-time event where the possibility of the event occurring is not assured, and a right can be sold giving the purchaser of the right the entitlement to purchase a ticket or entry to the event if it were to become certain. (The present invention is not limited in scope as to whether a right, e.g. a security, is regulated by a governmental agency. Also, a ticket can assume numerous forms, including a paper ticket and an electronic ticket.) The types of events to which the present invention may be applied include, but are not limited to: professional sports post-season games, college post-season games, bowl games, bracketed tournaments and any other type of domestic and international sporting or entertainment events. Once the rights are sold, they may be further traded on a secondary market.

The rights themselves are a unique entity representing the entitlement to purchase a ticket to an uncertain event if the event becomes certain. As noted above, certificates can represent the rights, in which certificates may take a variety of forms. In one embodiment, the certificate(s) are an attachment to a season ticket package. Alternatively, they could be split separately from season ticket package. In another embodiment, each right may be represented by a stand-alone certificate, with each certificate representing a single seat or a seat within a defined region of an event venue. In yet another embodiment, the certificates may represent “strips” or packages representing various configurations of available events. For example, a strip may include all possibilities for a given team's post-season games. Using Major League Baseball (MLB) as an example, various strips may comprise all NL/AL East, Central or West post-season game possibilities, all NL or AL post-season game possibilities or all MLB post-season game possibilities. Different purchase prices for rights may be put on each different type of strip. Furthermore, the certificates themselves can be embodied as an electronic or traditional physical document. Regardless, each certificate representing each seat within an event venue includes a unique code for identification and trading.

A variety of pricing alternatives are available for such rights. For example, a flat price may be charged for each right. Alternatively, different markets may be created based on seating regions such that seats in one region command a different price from seats in another region. Various other combinations of pricing factors will be readily apparent to those having ordinary skill in the art. The opportunity to purchase rights can likewise be done in a variety of manners. For example, the rights may be made available before a sporting season begins, during the season, or throughout the season at different times. Initial distribution could go to preferred customers, such as season ticket holders or special members of an organization, followed by offers to the general public. Within each of these categories, distribution could be further refined as first come first served or through random selection. Again, those having ordinary skill in the art can create a variety of distribution methods without departing from the spirit and scope of the present invention.

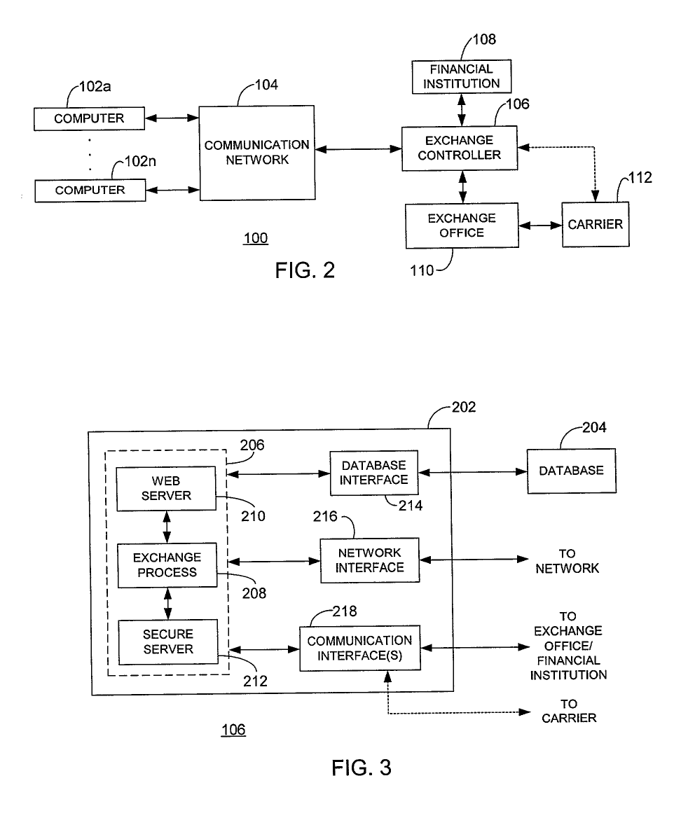

As mentioned above, rights, once sold, may be transferred through a secondary market. To facilitate this, rights may be fully or partially transferable. While a variety of mechanisms may be used to facilitate such a secondary market, it is preferred to use an electronic exchange to trade the rights if the rights are transferable. (However, the present invention does not preclude cases in which rights are not transferable and thus the secondary market is not applicable.) Such an exchange is described below with reference to FIGS. 2-4. Just as the particular scope of a given right may vary, so to can the types of secondary markets vary. For example, markets can be established to trade individual seat locations. Other markets may correspond to rights in which each right to purchase covers a unique region within a venue. Essentially, a separate market can be established for each different type of right available. Conversely, once a particular event has been eliminated as a possibility (i.e., when the condition(s) leading to the occurrence of the event can no longer be satisfied), the market for rights on that event can be eliminated. Alternatively, in the case where the event is part of a larger strip covered by a given right type, the market would be adjusted to exclude that event, presumably allowing trading levels to adjust accordingly. These are but a few of the many examples of markets that can be created for rights created in accordance with the present invention.

A particular example of the present invention might be applied to Major League Baseball, and the potential benefits accruing there from, is now described. Under such a program, all thirty MLB teams could sell certificates, at the beginning of every season, for each of the ten (10) or eleven (11) possible post-season games they may host. Certificates would be in the form of a right to purchase playoff tickets at the regular stated price for a specific seat location or within a predefined zone within a stadium, when they become available for sale. Rights could be issued in an electronic form with a unique serial number identifying the specific certificate or in a traditional document form. Once the rights have been sold, an automated exchange could be setup to trade the certificates electronically. A transaction fee could be charged on all transactions within the automated exchange.

Playoff ticket certificates would be sold annually with season ticket holders automatically issued the rights associated with their season ticket purchase. To increase the value to season ticket holders, additional rights may be offered for purchase before sales to the general public. Sales to the general public could be made through a lottery system, first come first serve, or through a market based approach. Certificates could be sold for individual games or in strips covering various possibilities including; a single team's complete ten (10) or eleven (11) game series, all AL or NL possibilities or the entire possible MLB spectrum.

The possibility of entering post-season play is an asset every team enjoys at the beginning of each season. To date, no team or league has fully realized this asset on an annual basis. Assuming conservative assumptions on the initial distribution and transaction revenue, the value to MLB could easily exceed one hundred million dollars ($100,000,000) annually and could go significantly higher. Even if a team has sold all of its season tickets, additional tickets that are not available for season purchase could have rights sold separately and traded throughout the season. Strip combinations could also be designed to include and encourage sales for less popular teams. All or a portion of the revenue generated from this program could also be used to establish more parity throughout the league thereby strengthening all MLB.

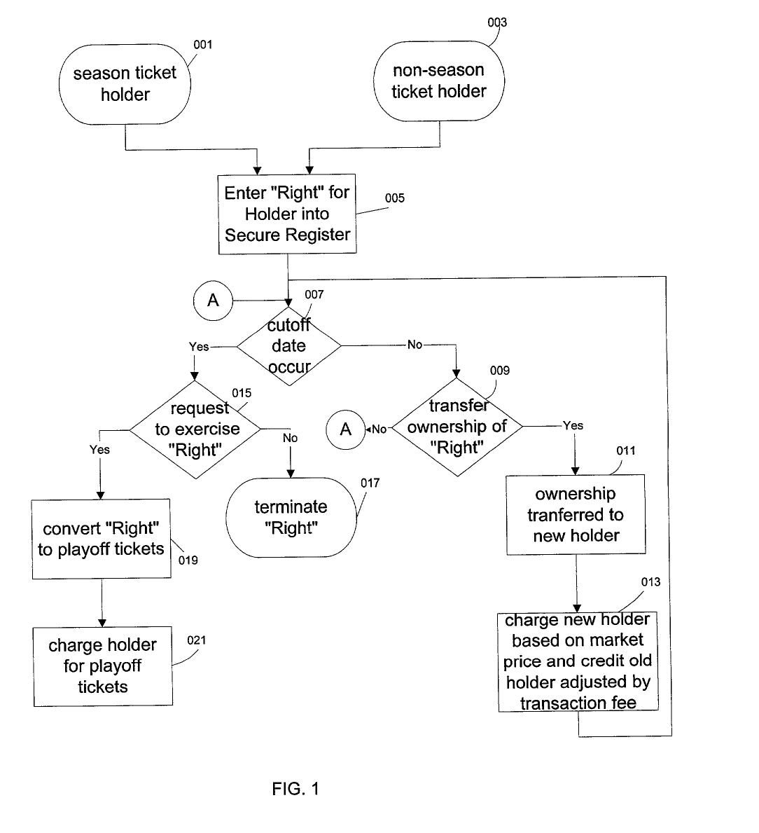

FIG. 1 is a flow diagram illustrating a first embodiment according to the present invention. With the exemplary embodiment, the holder of a right is entitled to purchase at least one event ticket by converting the right. In such a case, the holder pays a predetermined amount of money to purchase the event tickets. The at least one event ticket can correspond to one ticket or can be a series of tickets (e.g. the tickets for the NBA playoff games).

Season ticket holder 001 or non-season ticket holder 003 obtains a right, in which the right is entered into secure register 005. In the exemplary embodiment, secure register 005 resides on exchange controller 106. (Exchange controller 106 is discussed in greater detail in conjunction with FIGS. 2-4.) Season ticket holder 001 can obtain a right as part of the season ticket package, in which the price of the season ticket package includes the right. Alternatively, the price of the right can be distinct from the price of the regular season tickets. Non-season holder 003 typically purchases a right separately from any regular season ticket.

In the exemplary embodiment, the right is registered in secure register 005, although alternative embodiments may permit rights to be held and traded in other ways. The right is registered in secure register 005 until a cutoff date has occurred as shown in step 007. If the cutoff date has occurred, the holder needs to decide whether to exercise the right in step 015. If the holder decides to exercise the right, as shown in step 019, the holder is charged for an amount of money for the at least one ticket. In the exemplary embodiment, as shown in FIG. 1, the at least one ticket corresponds to a series of tickets for the team's playoff games. If the holder decides not to exercise the right, the right expires (terminates) in step 017.

Other embodiments can generalize the conversion process as shown in steps 007, 015, 017, 019, and 021 in which the right does not have a “hard” cutoff date. In such cases, the price of the right is adjusted in accordance to possible number of games that can be played in the remaining portion of the playoff games.

In step 007, if the cutoff date has not occurred, the holder can request that the ownership of the right be transferred to a new holder. Such a request can be predicated on the seller (the holder of the right) agreeing to the offered price for the right by the buyer (the new holder of the right). In such a case, secure register 005 in conjunction with event controller 106 registers the right to the new holder as shown in step 011. Even though secure register 005 is logically associated with exchange controller 106, secure register 005 may or may not physically reside at exchange controller 106. The new holder pays (is charged on a credit card for example) an amount of money according to the market value of the right. If the cutoff date has not occurred at this point of time, the process continues so that another transfer of the right can occur.

The structure discussed below in relation to FIGS. 2-4 may be used to implement the trading techniques described above. FIG. 2 illustrates a computer system 100 comprising a plurality of computers 102 in communication with each other through a communication network 104. An exchange controller 106, coupled to the communication network 104, is capable of communicating with the computers 102. In a preferred embodiment, the communication network 104 comprises a publicly available computer network, such as the Internet or World Wide Web. However, it is understood that the present invention is not limited in this regard; the network 104 may comprise or include a private computer network. Each of the computers 102 is preferably a personal computer, typically for use in the home or office. At a minimum, each computer 102 should support a common communication protocol with the exchange controller 106, preferably the so-called TCP/IP suite of protocols used to support Internet and “ETHERNET” communications. Of course, other communication protocols could be equally used dependent, in part, upon the type of communication network 104 employed.

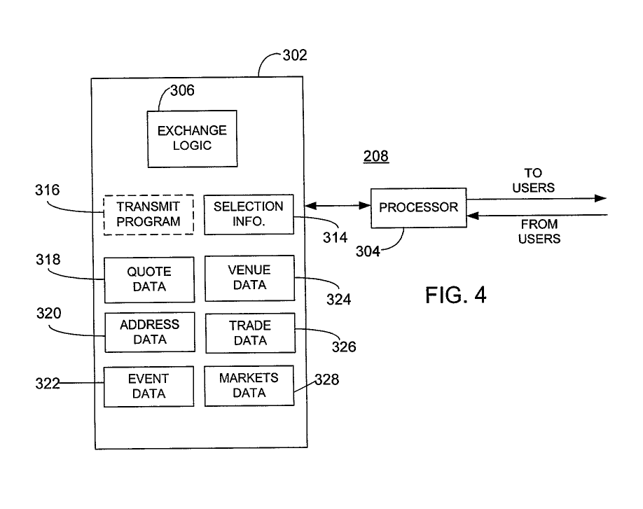

The exchange controller 106 serves to implement an on-line commodities exchange in accordance with the present invention and will be described in further detail with reference to FIGS. 3 and 4. Generally, the exchange controller 106 functions to automate interface operations with potential buyers and sellers of a given commodity, to implement exchange functionality (e.g., display market information, identify potential trades, etc.), and to support settlement activities. To this end, the exchange controller 106 is in communication with one or more financial institutions 108 capable of verifying customer credit availability and limits, issuing payments, holding funds while awaiting transaction clearance and the like. The exchange controller 106 is also in communication with an exchange office 110. The exchange office 110 includes personnel required to maintain operation of the exchange controller 110, field customer inquiries where necessary, ensure order settlement and to generally administer operations of the exchange. In the exemplary embodiment of the present invention, the exchange office 110 communicates with a carrier 112 in order to facilitate settlement of completed transactions. That is, the exchange office 110 receives information regarding completed transactions (transactions in which a buyer agreed to a seller's offering price or in which a seller agreed to a buyer's bid price) from the exchange controller 106 and forwards any information necessary for a carrier 112, if required, to perform delivery of the desired goods. It is anticipated that communications between the exchange controller 106 and the carrier 112 can also be performed directly (as illustrated by the dotted link) such that the necessary information is forwarded directly to the carrier 112 once a transaction has been completed.

Referring now to FIG. 3, a more detailed view of the exemplary embodiment of the exchange controller is provided. The exchange controller comprises at least two servers 202, 204, such as “SUN” “ENTERPRISE” 250 servers, operating in combination to provide an on-line exchange system. It is understood that the present invention need not be limited to an on-line implementation, and is susceptible to other implementations. For example, communications between individuals and the exchange controller 106 could be carried out using telephone, facsimile, postal mail or other off-line methods of communication. It is further understood that other implementations (including various hardware implementations) encompassing the same functionality as described herein will be readily apparent to those having ordinary skill in the art. In the implementation shown, a first server 202 communicates via a database interface 214 with a second server configured to operate as a database 204. Techniques for configuring servers in this manner are well-known in the art. The database 204 stores all relevant information necessary to complete commodities transactions, such as buyer and seller identifications, account identifications, passwords, information regarding specific quotes (bids and/or offers), credit information, etc.

The first server 202 implements the exchange functionality 206. As shown, the exchange functionality 206 encompasses an exchange process 208, a web server 210 and a secure server 212. Although not shown, the first server 202 comprises one or more processing units (such as microprocessors, microcontrollers, etc.) executing stored, computer-readable instructions to provide the exchange functionality 206. Likewise, the various interfaces 214-218 shown incorporate hardware and software implementations, as known in the art.

The exchange process 208 implements functionality, other than user-interface functionality, necessary to provide an automated commodity exchange system including, but not limited to, providing data to the web server 210 for presentation to a user of the exchange system. The exchange process 208 will be described in further detail with regard to FIG. 4. The web server 210 handles all non-secure interactions between the exchange controller and the computers 102 residing on the computer network 104. In a preferred embodiment, data received from the exchange process 208 by the web server 210 comprises HTML-compliant data suitable for presentation via a web page. In contrast, the secure server 212 handles all secure interactions (such as would be used when providing financial account data or other confidential information to the exchange controller) between the controller 106 and computers 102.

The network interface 216 couples the controller 106 to the computer network 104. This includes support and termination of network protocols necessary to communicate via the computer network 104. In particular, the network interface 216 operates to recognize transmissions intended for the exchange controller and, in a similar manner, to ensure that communications being sent to various computers 102 are properly routed. Although shown as a separate component from the web server 210 and secure server 212, it is understood that the functionality provided by the network interface 216 could be incorporated into one or both of the servers 210, 212.

As shown, the communication interface(s) 218 allow the controller 106 to communicate with the exchange office 110, for example through the use of a dial-up line, a direct T1 connection or the like, or a secure Internet connection. The communication interface(s) 218 may also be used to communicate with one or more financial institutions using, for example, a direct T1 connection or the like, or a secure Internet connection. Additionally, the communication interface(s) 218 can be used to directly communicate with carriers used to settle the various transactions, although non-automated communications with such carriers are also possible and would provide, at least initially, a more easily implemented alternative.

Referring now to FIG. 4, a more detailed view of the exchange process 208 of FIG. 3 is presented. The exchange process 208 is preferably implemented using computer-readable instructions and data structures stored on a computer-readable medium 302 and executed by a processor 304 (e.g., a microprocessor, microcontroller and the like). Additionally, the computer-readable medium 302 may also store data that is manipulated by the processor 304 in conjunction with the execution of the computer-readable instructions. The processor 304 is preferably resident on the first server 202, whereas the computer-readable medium 302 may reside in the first server 202, the database 204 or a combination of the two. Although the computer-readable medium 302 preferably comprises random-access memory (RAM) and/or read-only memory (ROM) resident in the exchange controller 106, the computer-readable medium 302 may also comprise other non-resident storage media, such as magnetic cassettes, floppy disks, flash memory cards, digital video disks, Bernoulli cartridges, RAMs, ROMs, and the like.

As shown, the computer-readable medium 302 comprises exchange logic 306, a selection information storage structure 314, an optional transmit program 316, quote data 318, address data 320, event data 322, seating data 324, trade data 326 and markets data 328. The exchange logic 306 implements those functions, preferably through the use of computer-readable instructions, susceptible to automation and necessary to conduct exchange operations. Such functions include, but are not limited to, processing user accounts, providing displays of markets, receiving bids and offers, recognizing matches between submitted bids and offers, processing acceptances of bids and/or offers and other exchange-oriented processing. Those having ordinary skill in the art will recognize other functionality useful in implementing an on-line exchange system may be similarly included in the exchange logic 306. The processor 304 executes the exchange logic 306.

The selection information storage structure 314 is adapted to receive selection information corresponding to the commodities being traded. Users of the exchange system, having viewed market information and/or a visual depiction and its corresponding regions, may enter selection information regarding various ones of the regions against which they desire to enter a bid or offer. Thus, the particular format of the selection information storage structure 314 is dependent, in part, upon the commodities being traded. For example, where a user selects a given region and submits a bid on commodities corresponding to that region, the selection information storage structure 314 must be able to store an identification of the selected region, a bid price and, in the event where a market may include suitable “sub-markets” (e.g., rows within a block of seats), identification of the “sub-markets” and corresponding bids. Those having ordinary skill in the art will recognize that storage for other information necessary for the proper operation of the exchange may also be included in the selection information storage structure 314.

As further shown in FIG. 4, quote data 318, preferably resident in the database 204, is available to the exchange process 208. The quote data 318 comprises all pertinent information regarding quotes provided by each market participant. Data structures necessary to provide linking of quotes are maintained, among other things, within the quote data 318. The address data 320 comprises all data relevant to any addresses used in the system. The event data 322 encompasses all pertinent information regarding events being held at various event venues described in the venue data 324. The trade data 326 includes all information relative to quotes that have been accepted. Finally, the markets data 328 is that data used by the exchange logic 306 to keep track of and present various markets to users of the exchange system.

In the exemplary embodiment of the present invention, at least portions of the data 314-328 collectively form a data structure suitable for implementing an on-line exchange system. In accordance with the methods described below, such a data structure can be provided in whole or in part to a user's computer (e.g., by downloading a web page comprising the data structure) and used to gather selection information. When all of a user's selection information has been stored in the selection information storage structure 314, the selection information is conveyed back to the exchange controller. This is illustrated in FIG. 4 where the processor 304 transmits the data structure and receives the selection information. As required, elements may be added to or removed from the data structure, thereby increasing its utility for a particular application. Further still, in an alternative embodiment of the present invention, the data structure includes the transmit program 316 in lieu of the selection information storage structure 314. The transmit program 316 is an optional program, such as a “JAVA” applet, included in the data structure that allows selection information to be transmitted to the exchange controller as it is received from the user, rather than waiting for all selection information to be received first. Those having ordinary skill in the art will recognize that other implementations are possible and are a matter of design choice.

It is to be understood that the above-described embodiment is merely an illustrative principle of the invention and that many variations may be devised by those skilled in the art without departing from the scope of the invention. It is, therefore, intended that such variations be included with the scope of the claims.

I/we claim:

1. A method that provides for a creation and a sale of a right in a commodity exchange system, the right entitling a current holder to purchase at least one event ticket, each event ticket associated with an event, the method comprising the steps of:
entering the right into a secure register for the current holder; and
converting the right to the at least one event ticket.

2. The method of claim 1, further comprising the steps of:
adjusting a value of the right; and
transferring ownership by the secure register of the right to a new holder in response to the current holder requesting a transaction of the right, wherein the current holder becomes the previous holder and the new holder becomes the current holder.

3. The method of claim 2, wherein the step of adjusting the value of the right terminates the right after a cutoff date occurs.

4. The method of claim 3, wherein the step of converting the right to the at least one event ticket occurs essentially at a cutoff date.

5. The method of claim 1, wherein the current holder is selected from the group consisting of a season ticket holder and a non-season ticket holder.

6. The method of claim 2, further comprising the step of:
charging the new holder an amount of money based upon a market value of the right.

7. The method of claim 6, further comprising the steps of:
adjusting the amount of money by a transaction fee; and
crediting the previous holder the amount of money.

8. The method of claim 2, wherein the at least one ticket corresponds to a series of events and wherein each event of the series is dependent upon a previous event.

9. The method of claim 2, wherein the step of transferring ownership by the secure register of the right to the new holder comprises the steps of:
receiving a quote from a user of the commodity exchange system, the user being either the current holder or the new holder of the right; and
receiving an acceptance indication corresponding to the quote.

10. The method of claim 1, wherein the right specifies a region within an event venue.

11. The method of claim 8, wherein the step of converting the right to at least one event ticket and the step of adjusting the value of the right occurs during a period of time in which a portion of the series of events is completed.

12. The method of claim 1, further comprising the step of:
distributing the right to a non-season ticket customer, wherein the non season-ticket customer becomes the current holder of the right.

13. The method of claim 1, further comprising the step of:
distributing the right to a season ticket customer, wherein the season ticket customer becomes the current holder of the right.

14. A method that provides for a creation and a sale of a right in a commodity exchange system, the right entitling a current holder to purchase at least one event ticket, each event ticket associated with an event, the method comprising the steps of:
providing market information for the right associated with at least one seat in an event venue;
receiving at least one of a quote acceptance and a quote proposal responsive to the market information.

15. The method of claim 14, further comprising the steps of:
determining recalculated market information based upon the quote acceptance or the quote proposal; and
providing the recalculated market information.

16. A method that provides for a creation and a sale of a right in a commodity exchange system, the right entitling a current holder to purchase at least one event ticket, each event ticket associated with an event, the method comprising the steps of:
defining quantity-differentiated markets for a plurality of rights, each right of the quantity-differentiated markets based on a unique number of units of the right to be traded; and
providing market information for at least one of the quantity-differentiated markets.

17. A method that provides for a creation and a sale of a right in a commodity exchange system, the right entitling a current holder to purchase at least one event ticket, each event ticket associated with an event, the method comprising the steps of:
receiving, from amongst a plurality of quotes provided by buyers and sellers, a first quote from a user of the commodity exchange system;
receiving at least a second quote from the user; and
linking the first quote and at least the second quote together to provide a quote chain, wherein acceptance of any quote in the quote chain causes remaining quotes in the quote chain to be inactivated, and wherein each quote in the quote chain is directed to at least one right within at least one event venue.

18. A method that provides for a creation and a sale of a right in a commodity exchange system, the right entitling a current holder to purchase at least one event ticket, each event ticket associated with an event, the method comprising the steps of:
defining spatially diverse regions within an area, each of the spatially diverse regions defining a separate commodity market, the right associated with one of the spatially diverse regions;
providing display data on the area, wherein each of the spatially diverse regions is separately identifiable by a viewer of a visual depiction resulting from the display data; and
receiving selection information corresponding to at least one selected spatially diverse region.

19. An apparatus that provides for a creation and a sale of a right in a commodity exchange system, the right entitling a current holder to purchase at least one event ticket, each event ticket associated with an event, the apparatus comprising:
a secure register, the secure register assigning the right with the current holder; and
an indication associated with the secure register signifying as to whether the current holder chooses to convert the right to the at least one event ticket.

20. The apparatus of claim 19, further comprising:
an exchange controller that interacts with a user of the exchange controller to generate quotes, the exchange controller communicating with the secure register about a transfer of the right to a new holder.

21. The apparatus of claim 20, further comprising:
a network interface connecting the exchange controller to the user through a communication network.

22. A computer-readable medium containing instructions for controlling a computer system to create and sell a right entitling a current holder to purchase at least one event ticket, by:
entering the right into a secure register for the current holder; and
converting the right to the at least one event ticket.

23. The computer-readable medium of claim 22, further containing instructions for controlling the computer system to create and sell the right entitling the current holder to purchase the at least one event ticket, by:
adjusting a value of the right; and
transferring ownership by the secure register of the right to a new holder in response to the current holder requesting a transaction of the right, wherein the current holder becomes the previous holder and the new holder becomes the current holder.

24. The computer-readable medium of claim 23, further containing instructions for controlling the computer system to create and sell the right entitling the current holder to purchase the at least one event ticket, by:
charging the new holder an amount of money based upon a market value of the right.

25. The computer-readable medium of claim 24, further containing instructions for controlling the computer system to create and sell the right entitling the current holder to purchase the at least one event ticket, by:
crediting the previous holder the amount of money; and
adjusting the amount of money by a transaction fee.

26. The computer-readable medium of claim 23, further containing instructions for controlling the computer system to create and sell the right entitling the current holder to purchase the at least one event ticket, by:
charging the new holder the amount of money.

27. The computer-readable medium of claim 23, further containing instructions for controlling the computer system to create and sell the right entitling the current holder to purchase the at least one event ticket, by:
receiving a quote from a user of the commodity exchange system, the user being either the current holder or the new holder of the right; and
receiving an acceptance indication corresponding to the quote.
